(19) United States
(12) Patent Application Publication
(10) Pub. No.: US 2014/0240134 A1
(43) Pub. Date: Aug. 28, 2014

(54) SYSTEM AND METHOD FOR THE DETECTION AND CONTROL OF ILLICIT TRAFFICKING OF SPECIAL NUCLEAR MATERIALS

(71) Applicant: INVAP S.E., San Carlos de Bariloche (AR)

(72) Inventor: Roberto M. Cibils, San Carlos de Bariloche (AR)

(73) Assignee: INVAP S.E., San Carlos de Bariloche (AR)

(21) Appl. No.: 14/097,292

(22) Filed: Dec. 5, 2013

(30) Foreign Application Priority Data
Feb. 28, 2013 (AR) P 2013 01 00651

(51) Int. Cl. G01V 5/00; G08B 29/18

(52) U.S. Cl. CPC G01V 5/0091; G08B 29/185
USPC 340/600

(57) ABSTRACT

It is a system and method for the monitoring of the illicit traffic of fissile materials that can be used for the construction of nuclear bombs or not fissile that can be used for the construction of radiological dispersion devices; characterized by reducing the rate of spurious detection and increase the probability of detection compared with equivalent devices of the prior art. Some of its embodiments include the use of a radiation detector/telemeter ensemble with manual or automatic pointing and an ensemble of radiation detector/camera with an automatic object tracker along with data acquisition and processing electronics; which allow the calculation of the correlation between the characteristic profile produced by the MO and a predicted reference profile. The detection electronics includes a gamma spectrometer and processing electronics for compensating for the shadow shielding effects. One or more radiation detectors are included together with their correspondent high voltage power supplies and signal conditioning and amplification electronics.

### FIELD OF THE INVENTION

The present invention, for which an US patent is requested, has as a main object a system and method for the detection and control of the illicit trafficking of special nuclear materials (SNM)¹ or any other illicit radioactive material by means of which it is possible the monitoring of people or vehicles in transit; reducing to a minimum any interference with its normal flow, for determining if one or more of them carry SNM; even though it is only temporarily in the presence of the detection system, moving along arbitrary trajectories with arbitrary speeds within a Monitored Area (MA) in an environment with natural radiation background. ¹ In accordance with the definition of the Nuclear Regulatory Commission of the United States

More specifically, the present invention covers a new system and method that outperforms the devices, installations or existing systems and methods, extending the limits of its ability to detect the presence of radioactive materials that can be illegally transported.

Theoretical Foundations

Currently the surveillance associated with the potential transport of special nuclear materials (SNM) is performed by different types of systems or devices. These systems are usually implanted in the border access points and are based on personnel or vehicle radiation portal monitors for primary inspections complemented with portable radioisotope identification devices (RIIDs) for secondary inspections.

One of the major limitations of these systems is the brief time period during which the monitored objects (MO) remain inside the field of view of the radiation detectors in the primary inspection phase. This period is chosen as a tradeoff between the maximum detection error rate and the maximum degree of traffic obstruction tolerated.

The classic technique of radiation monitoring is based on the measuring of the count rate produced by the gamma photons or neutrons emitted from the MO. This count rate is produced by at least two components: a) natural radiation sources (soil, construction, cosmic radiation, etc.) resulting in what is called the background radiation and b) artificial radiation sources, one of which can be SNM or radioactive materials that could be used for the construction of radiological dispersion devices.

The detection processes use the statistical hypothesis testing method to determine if the magnitude of the measured radiation level is derived exclusively from these natural radiation sources or contains a component that is different from them. This test consists in deciding on the validity of two hypotheses: H0 (there is only background radiation) and H1 (there is not only background radiation) from the statistical properties of the acquired data. These processes allow identifying only a fraction of the cases in which the system is in the presence of artificial radiation sources at a certain rate of false detections.

The alarm occurs each time the measured parameter exceeds a threshold that could only have been reached by fluctuations of the natural radiation background in very improbable conditions. It should be noted that the higher this threshold, the lower the false alarm rate will be. However, it also will be higher the number of cases of illegal trafficking of radioactive materials that will not be detected.

The greater or lesser success in solving this conflict between the probability of detection and the false alarm rates determines the quality of the detection system. The first figure of merit (probability of false positive α) determines the efficiency that can be achieved in the flow control of people and goods across the border without hindering the normal traffic. The second figure of merit is the probability P of detecting true cases of illicit traffic (P=1−β) where β is the probability of false negatives. This figure is related to the rate of cases in which the illicit radioactive material can circumvent the surveillance and is therefore associated with the maximum tolerated level of risk.

The determination of the MO's radiation level is achieved through the measurement of the count rate it produces. This count rate is proportional to the flow of radiation that passes through the detector effective surface. The count rate measurement is performed by integrating the number of pulses produced by the gamma photons or neutrons that arrives to the radiation detector surface with enough energy to be distinguished from the electronic noise during a time period called “the integration period”.

The process of taking into account only those pulses generated by gamma photons, whose energy range is within the range emitted by the material of interest, eliminates much of the alarms produced by the natural background or benign radiation sources such as naturally occurring radioactive materials (NORM) or radioactive materials used in nuclear medicine.

The detection errors rate depends inversely on the square root of the number of photons detected. If the source is not in motion, this uncertainty can be reduced by increasing the integration period. However, this is not applicable when the transit period of the radiation source is as brief as it is in this type of monitoring.

Further increases of the detection errors rate are produced by the shadow shielding. This is the shielding produced by the vehicles on the background radiation as they pass through the monitoring area (MA). All the detection processes are based on the assumption that background activity is constant throughout the period of data acquisition. However, this premise is not met because this shadow can depress the measured level of background radiation up to 30 percent when the vehicle is large and is directly in front of the detector. Fortunately techniques such as the use of normalized values for the calculation of the spectral distance between the background and current radiation count rates allow mitigating this effect.

It should be added to this limitation the fact that in most cases the illegally transported materials are hidden by shields which strongly attenuate the radiation emitted by the MO. All of these factors define a base level in the detection errors rate. The value of this base level depends on the maximum cost of the radiation detectors that can be afforded and in the maximum transit time per vehicle tolerated.

In these conditions, a system which reduce the rate of detection errors by extracting additional information from the data acquired by the detection system while keeping the same inspection period represents a technological improvement with respect to the prior art.

### PREVIOUS ART

The following patents are related to different devices that have been proposed for the passive monitoring of radioactive materials in transit up to now:

US4509042, 1985, Portal Radiation Monitor. It includes a radiation portal monitor which uses pulse shape discrimination, dynamic compression of the photomultiplier output and scintillators sized to maintain efficiency over the entire portal area.

US5679956, 1997, Enhanced Vehicle Radiation Monitoring System and Method. It includes a system and method for the detection of ionizing radiation emitted by an object. It is characterized by at least one radiation detector for the measurement of the ionizing radiation level, a sensing device for evaluating the characteristic shape of the monitored object, and a processor operationally connected to both. The output of the characteristic shape is used to compensate for the variations in the radiation background level emanating from the different shapes of the monitored object. With such a system, the possibility of a false alarm induced by the geometry of the object is minimized.

US5705818, 1998, Method and Apparatus for Detecting Radioactive Contamination in Steel Scrap. This is a method for monitoring radioactive contamination of scrap contained in a moving railway car. Every time that the presence of a moving wagon is detected it is scanned for radioactive contamination. The identification of the railroad car is determined through a RFID system. The scanning is deactivated when the vehicle is no longer present. Once scanning is complete, it is determined if the vehicle is contaminated.

US6727506, 2004, Method and Apparatus for a Radiation Monitoring System. A radiation monitoring system for detecting the radiation emitted by moving objects traveling at a wide range of speeds, including the high speeds normally encountered with vehicles driven on highways, interstate thoroughfares, railroads and conveyors. At least two and preferably three radiation detectors are employed, spaced apart in series separated from each other along the direction of travel of the moving object or vehicle. The results are linked by an identification system such as a webcam or other photographic device which produce visual identification of the objects or vehicles.

US2005029460/US20067045788, 2006, Multi-way Radiation Monitoring. It is a surveillance system capable of detecting a radiation source on or within traffic organized in M different rails. It comprises a set of (M+1) radiation detector assemblies positioned at each of two sides of each of the M adjacent traffic ways. It includes a set of M controllers attached to the respective individual sets of detectors placed on both sides of its corresponding track. In this way each controller shares a set of detectors with its two adjacent ones. The (M−1) groups of detectors located between rails can detect the radiation of objects travelling in any of their adjacent rails.

US7064336, 2006, Adaptable Radiation Monitoring System and Method. It comprises a portable system capable of detecting radiation sources moving at high speeds. The system has at least one radiation detector capable of detecting gamma radiation, coupled to a MCA capable of collecting spectral data in very small time bins of less than about 150 msec. A computer processor is connected to the MCA for determining from the spectral data if a triggering event has occurred. The spectral data is stored on a data storage device. Several configurations of the detection system can be suitably arranged to meet various scenarios of radiation detection. In a preferred embodiment, the computer processor operates as a server which receives spectral data from the other networked detection systems and communicates the collected data to a central data reporting system.

US0001123, 2007, A Method and Apparatus for Detection of Radioactive Materials. It consists of an array of radiation detectors of which at least one is capable of detecting low and high energy gamma radiation and is adapted to provide spectrometric identification of the gamma source. It includes in addition at least one detector capable of detecting and providing spectrometric identification of fast neutrons and low resolution gamma spectra. It also provides at least one detector adapted to detect thermal neutrons and at least one plastic scintillator to give enhanced gamma rays sensitivity.

US0104064, 2010, System and Method for Thread Detection. The system includes an imaging detector with the ability to form an image from the radiation emitted by a radiation source. This image is produced by back-projecting the radiation via an image reconstruction technique using a digital processor. This processor generates a first set of image pixels identifying the location of the radiation sources and a second set identifying those that involve a potential security risk.

US0261650, 2011, Method for the Radiation Monitoring of Moving Objects and a Radiation Portal Monitor for Carrying Out Said Method. It consists of a radiation monitoring portal and can be used to detect unauthorized movement of radioactive material. It differs from other portals in that it uses an ultrasonic telemeter for accurately determining the exact point where the monitored object enters the monitoring area.

US0266454, 2011, Method for Detecting Contamination of a Moving Object. It is a method to detect contamination of a moving object based on the use of a portal containing three columns of gamma radiation and/or neutrons detectors on each side. This method includes a procedure to validate the results of the radiation detection process using the patterns that produces a radiation source when passing close to each column.

All the systems for radiation monitoring which are described in these patents base their operation in the comparison between the radiation levels measured before and after the incoming of the MO to the MA. All these systems do not take advantage of all the information produced during the monitoring process and their performance is influenced by the poor statistics of the radiation data acquired in short transit times.

The present invention includes for detection a new characteristic parameter. This parameter is the degree of linear dependence between the radiation flux profile produced during the transit of the MO and a reference profile predicted from the acquired MO trajectory, assuming he is carrying a radiation source.

All the previous systems are forced to use high thresholds for triggering alarms in order to reduce the false positives rates produced by the statistical fluctuation of the background radiation. This threshold is calculated from the mean value of the background plus a certain number of times its standard deviation (sigma). A two sigma factor in the calculation of this threshold implies a false positive rate of about a 5%, while a three sigma factor reduces this rate to approximately 0.3%.

Because of shielding, the levels of radiation produced by the illicit radioactive material that reach the detector will be extremely low. As a consequence the use of high alarm thresholds imply a low probability of detection.

This invention, overcomes this limitation because the standard deviation of its main detection figure (the Pearson correlation coefficient) is many orders of magnitude lower than the same parameter in the traditional detection figures when the H0 hypothesis is valid, even with the lowest levels of radiation.

### SUMMARY OF THE INVENTION

The system referred to in the present invention, takes advantage of the fact that the radiation flow depends on the solid angle subtended between the radioactive object's center and the radiation detector's surface. This angle depends inversely on the square of the distance between the radiation source and the detector. From this, the radioactive object in motion will produce a radiation flow profile on the detector which will depend on the shape of its trajectory as long as it stays inside the field of view of the detection system.

With the invented system, in addition to comparing the radiation levels before and during the transit of the MO through the detection system (as in the traditional techniques), it evaluates the correlation degree between the acquired radiation profile and the estimated one.

The estimated profile is obtained in real time by using the MO-detector distances d and the radiation data, both measured while the MO was inside the field of view of the detection system. The final result of this correlation process indicates the degree of linear dependence r between the acquired radiation profile and the profile predicted from the trajectory's shape. This information, which up to now has not been used by any surveillance system, allows solving more effectively the conflict produced between the rates of true and false detections by increasing the amount of information that is available from the monitoring process.

The innovation component of this patent consists in taking advantage of this new source of information. It has been verified by using Monte Carlo simulations that the addition of this process to the traditional ones reduces significantly the detection error rates and increase the sensitivity of these systems.

### BRIEF DESCRIPTION OF THE DRAWINGS

In order to clarify the concepts previously discussed and their advantages, to which experts in this field will add many more, and to facilitate the understanding of constructive, constitutive, and functional characteristics of the potential applications of the invented technique, several schematic illustrations are represented, with the clarification that it does not correspond assigning to them a limitative or exclusive nature for the scope of the patent protection, but simply assist in explaining and illustrating the basic concept on which it is based.

FIG. 1 shows the basic architecture of the prior art devices.

FIG. 2 shows one embodiment of this invention. In this particular case it shows a radiation detector attached to a telemeter; both pointing to the MO along its trajectory.

FIG. 3 shows another embodiment of this invention. In this case, the intrinsic efficiency of the radiation detector is independent of the MO position, so it does not need to rotate during the transit period. The MO-detector distance at each point or the trajectory is determined automatically from images taken by a camera whose field of view covers the entire MA.

FIG. 4 shows the main block diagram of this invention.

FIG. 5 shows the block diagram of the Radiation Detection Electronics used by this invention.

FIG. 6 shows the block diagram of the Profile Calculator used by this invention.

### DETAILED DESCRIPTION

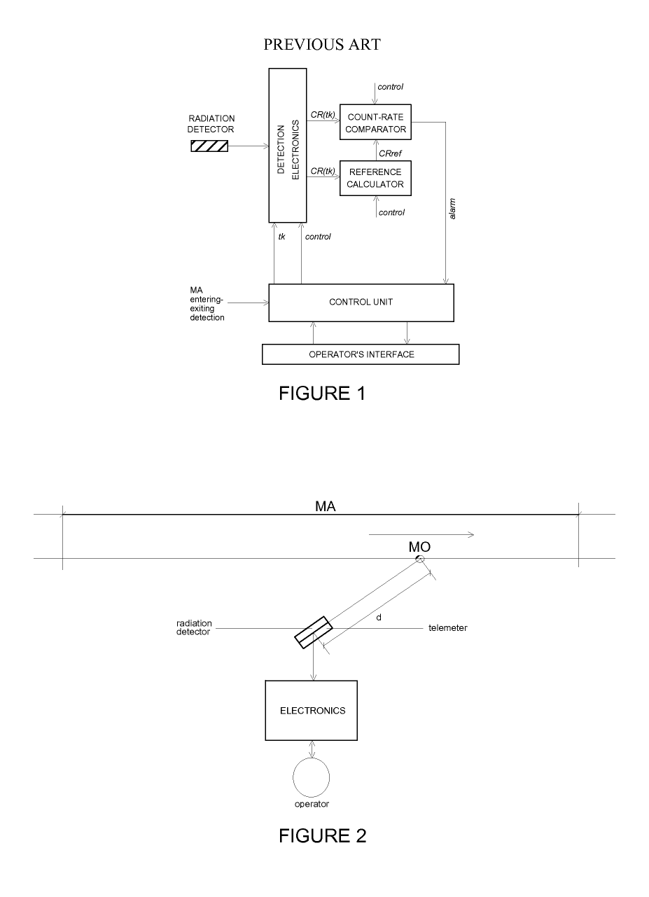

The generic architecture of the prior art shown in FIG. 1 is used (with slightly differences for each case) by most of the perimeter monitoring systems for illicit traffic of radioactive materials. Note that in this case, only the radiation count rate is measured and this is done in two phases:
The first occurs when the MO is still outside the MA and is performed for determining the value of the C_{R0} count-rate produced by the background radiation.
The second occurs during the transit period of the MO traveling through the MA. This is performed for determining if the count-rate C_{R} has increased beyond the critical value used in the statistical hypothesis test for signaling the presence of radioactive materials.

Different processes are used in this prior art to determine if the alarm condition occurs. These range from the simple comparison of the “in-transit” measurement with a critical level, to the application of more sophisticated algorithms such as Sequential Probability Ratio Test [2].

The entry and exit of the MO in the MA are monitored by special sensors not shown in this diagram.

For the system proposed in this invention the MO-detector distance measurement is essential. It is convenient for all the embodiments of this invention, that the intrinsic efficiency of the radiation detector remains constant during all the transit period; or in other words the effective surface of the detector remains the same for all the radiation source positions. In the specific case of the embodiment shown in FIG. 2 this is achieved by keeping the radiation detector pointed toward the MO using manual or automatic control during all the data acquisition period. In this way the sensing area of the detector will always be facing the MO during his transit through the MA.

The process implemented by this invention has two phases: a) the data acquisition phase and b) the data processing phase. The first phase occurs during the transit period, while the second occurs immediately after. If the embodiment shown in FIG. 2 has manual operation, the system's appearance may look like a radar gun; similar to that used for measuring speed by Doppler Effect. The process will be initiated by the coincidence (AND) of two conditions: a) the trigger pull and b) the MO entrance. The end of the acquisition phase is produced by one of two alternative conditions (OR): a) the system memory saturation or b) the MO exit. If the embodiment is automatic, it must be implemented as a fix installation close to the edge of a transit zone. In this embodiment the device shall include a mechanism for tracking the MO while he is crossing through the MA.

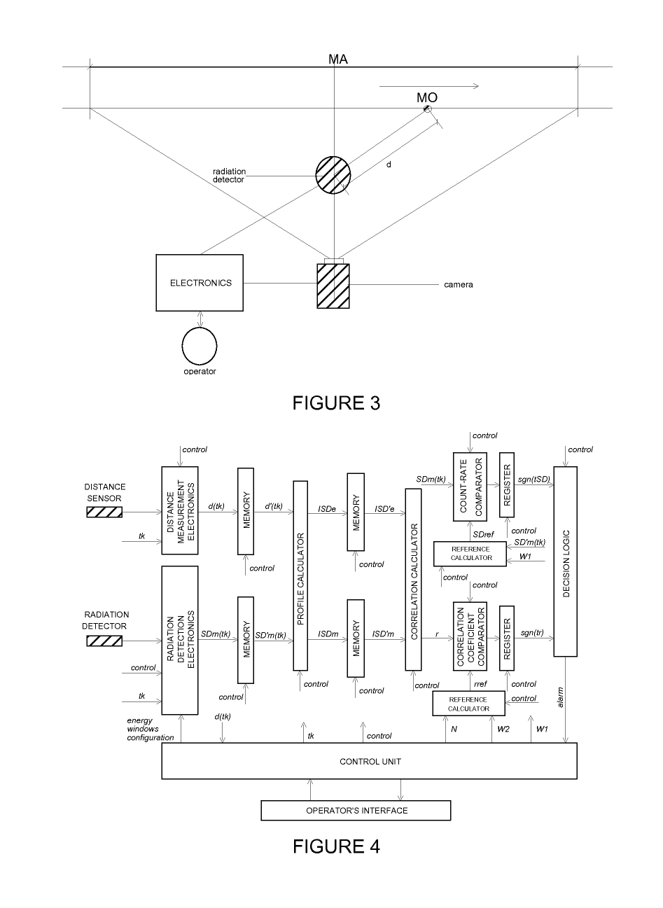

In the embodiment shown in FIG. 3 the measurement of the MO-detector distance is implemented without moving parts. In this case, a camera acquires images of the MA periodically. The radiation detector(s) is (are) in a strategic position located within the field of view of the camera. An image processing unit executes a program for automatic identification and tracking of the MO. It detects the moment of entrance of the MO into the MA and also the moment at which the MO leaves it; starting and ending the acquisition phase. The MO-detector distances are extracted from each image through a process of calculation based on trigonometric relations. The data processing phase begins once finished the acquisition phase. Another possible embodiment can perform simultaneous monitoring of several MO by using an extended version of this tracking function. This extended version shall include the capability for calculating an estimate of the radiation activity for each of the MO by using the back-projection method. The intrinsic efficiency of the detectors used for this embodiment can be made approximately independent of the MO position by selecting the proper shape.

FIG. 4 shows a block diagram describing the architecture of this invention. In this figure, the acquisition phase functions are implemented using a generic distance sensor, a radiation detector and their respective electronics.

The data acquired by both inputs are stored in two separate memories for further processing. As discussed before, the implementation of the distance sensor and its associated electronics will depend on the chosen embodiment. They can range from some kind of telemeter to a complex device for the acquisition and processing of images. Its output data will be the MO-detector distances d, measured at uniformly spaced sampling times tₖ. These sampling times are determined by a periodic signal produced by the Control Unit, which ensures the correct synchronism between the distance values d(tₖ) and the radiation values that are expressed in terms of spectral distances SD(tₖ).

The time series SDₘ(tₖ) represents the measured profile produced by the transit of the MO through the MA. Their stored values SD′ₘ(tₖ) are used by the Profile Calculator in the data processing phase to generate the estimated reverse profile ISDₑ, whose stored values are ISD′ₑ. This module also provides the measured reverse profile ISDₘ. Both profiles are correlated in the Correlation Calculator. This last module carries out different calculations of the Pearson correlation coefficient r each one having a different time-shift δ between them:

$$r ( δ ) = \frac{cov ar ( {ISD}_{m}^{′} , {ISD}_{e}^{′} ( δ ) )}{{σ}_{m} \cdot {σ}_{e}} \qquad ( 1 )$$

where the function covar(ISD′ₘ,ISD′ₑ) is the covariance between the time series ISD′ₘ y ISD′ₑ(δ), σₘ and σₑ are the standard deviations of the measured and estimated profiles respectively and δ is the time-shift applied to ISD′ₑ for the calculation of the different values of the correlation coefficient.

The upper Reference Calculator calculates the SD_{TH} detection threshold for the traditional detection technique using the following calculation:

SD_{TH}=W₁·σ_{SD} (2)

where W₁ is the predefined number of standard deviations that should be used in the alarm threshold calculation to achieve the tolerated rate of detection errors and σ_{SD} is the standard deviation for SDₘ(tₖ) when there is only background radiation. W₁ is configured at the beginning of the operation by the system operator using Operator's Interface, while σ_{SD} is calculated by the Reference Calculator from SD′ₘ(tₖ).

With these data the Count-Rate Comparator calculates a residuals vector t_{CR} whose components are:

$${t}_{CR} = \frac{{SD}_{m} ( {t}_{k} ) - {SD}_{TH}}{{σ}_{SD}} \qquad ( 3 )$$

The outputs of this module are the values of the residuals' sign. These values are stored in a register for further processing in the Decision Logic Unit.

One of the functions of the Control Unit is to determine the number N of samples SDₘ(tₖ) to be acquired and transfer this value to the lower Reference Calculator at the end of the data acquisition phase. This module calculates the second alarm threshold z_{TH} making the following calculation:

$${z}_{TH} = \frac{{W}_{2}}{\sqrt{N - 3}} \qquad ( 4 )$$

where N is the number of acquired samples and W₂ is the chosen threshold expressed in terms of the number of standard deviations required to achieve the tolerated rate of detection errors. This threshold is initially configured by the system operator using the Control Unit.

The Correlation Coefficient Comparator module calculates in first place the Fisher z transform of the Pearson correlation coefficient making the following calculation:

$$z = \frac{1}{2} \cdot ln ( \frac{l + r}{l - r} ) \qquad ( 5 )$$

and then normalizes this value in agreement with the t-student statistics generating the residual tᵣ:

tᵣ=(z−z_{TH})·\sqrt{N−3} (6)

The output of this module is the sign of the residual. This value is stored in a register for further processing in the Decision Logic unit.

In the Decision Logic unit both detection techniques are combined for determining the existence of radioactive materials inside the MA. For this, the signs of tᵣ and t_{CR} are evaluated (see TABLE I). If both figures are negative the H0 hypothesis is chosen (meaning that the MO is not carrying radioactive materials). If any of them is positive the H1 hypothesis is chosen, meaning the opposite.

TABLA I

| tᵣ | t_{CR} | RESULTADO |
|---|---|---|
| − | − | H0 |
| − | + | H1 |
| + | − | H1 |
| + | + | H1 |

The Control Unit provides the signal tₖ for synchronizing the sampling time in the Distance Measurement and the Radiation Detection Electronics. It also coordinates all internal operations in both the data acquisition and the data processing phases and determines the amount N of samples acquired during the first one. In addition to these functions, the Control Unit determines the beginning and the end of the data acquisition phase based on the data provided by the Distance Measurement Electronics. It also provides the operator with the capability to configure the splitting of the energy spectrum in S different windows in the Radiation Detection Electronics.

The Operator's Interface is a smart unit that communicates with the Control Unit for system configuration and alarm display.

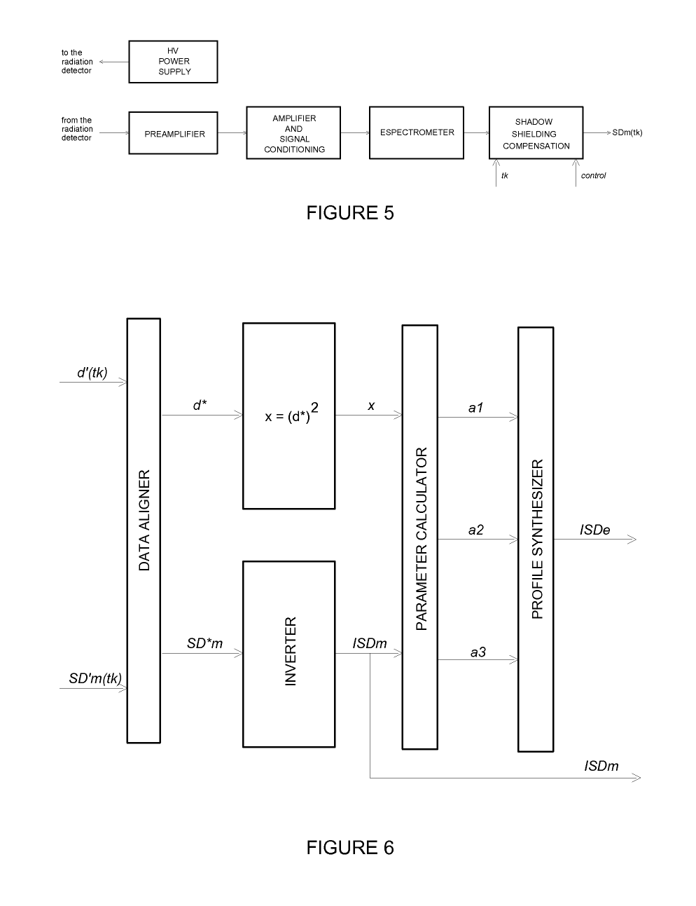

The Radiation Detection Electronics shown in the block diagram of FIG. 5 produces an electronic pulse each time a particle of radiation impacts on the detector's sensing area with the appropriate energy level. These pulses are counted and classified by energy in the spectrometer. The acquired spectrum is used in the Shadow Shielding Compensation module for each sample in order to calculate the spectral distance as:

$$SD ( {t}_{k} ) = \{ {\sum }_{i = 1}^{S} {[ \frac{CR {0}_{i}}{CR 0} - \frac{{CR}_{i} ( {t}_{k} )}{CR} ]}^{2} \} 1 / 2 \qquad ( 7 )$$

where CR0ᵢ is the i-th spectral component of the radiation background count rate, CR0 is the value of the background count rate integrated over the entire spectrum, CRⱼ(tₖ) is the i-th spectral component of the count rate measured at the tₖ instant during the data acquisition phase and CR is the value of the current count rate, integrated throughout the entire sample energy spectrum.

FIG. 6 shows the block diagram of the Profile Calculator used in this invention. The first function of this module consists in the automatic alignment of the data vectors SD(tₖ) and d(tₖ) in such a way that the maximum of the first match with the minimum of the second. This is performed automatically for matching the reference point, located arbitrarily on the MO and used to measure the MO-detector distance, with the actual position of the radiation source. Subsequently the ISDₘ and x data vectors are calculated.

For the generation of the estimated profile the Parameter Calculator calculates the characteristic parameters a₁, a₂ and a₃ from the relationship that exists between the inverse spectral distance ISDₘ and the square of the physical MO-detector distance. (x=d²).

ISDₘ=a₁·x²+a₂x+a₃ (8)

This estimate is performed by applying the linear least square fit method with the data vectors ISDₘ and x.

Once finished this process, the parameters are stored in registers and the Profile Synthesizer starts the process of calculating an estimate of the profile, which is performed by calculating:

ISDₑ=a₁·x²+a₂x+a₃ (9)

### REFERENCES

[1] P. E. Fehlau, “Perimeter Radiation Monitors for the Control and Physical security of Special Nuclear Materials”, Proceedings of the Symposium on Access Security Screening, 28-30 Mar. 1990
[2] A. Wald, “Sequential Tests of Statistical Hypotheses”, Annals of Mathematical Statistics 16 (2), June 1945

1. SYSTEM AND METHOD FOR THE SURVEILLANCE OF ILLICIT TRAFFICKING OF SPECIAL NUCLEAR MATERIALS, of the type designed to implement a monitoring process in an area with traffic of people or vehicles which could carry potentially dangerous special nuclear materials (SNM) such as uranium or plutonium and reducing its false alarms rate, presenting the capability to measure the degree of linear dependency between the measured radiation profile and a different profile synthesized from the same measured data, using for this measurement the radiation count rate as well as the MO-detector distance, for which manual pointing is required, characterized because it is used in combination: a radiation detector firmly attached to a digital telemeter for measuring the MO-detector distance and added to the standard components of the prior art (high voltage power supply, preamplifier, amplifier and signal conditioner), a spectrometer for classifying the radiation pulses, distributing them in different energy windows and a shadow shielding compensator that calculates the spectral distance of each sample; a reference radiation profile synthesizer which calculates the ideal radiation profile that would be produced by the MO if he were carrying NMS with a radiation level equivalent to the measured; a correlation coefficient calculator for calculating the Pearson correlation coefficient between the measured and the estimated profile, a comparator device for comparing the values of the obtained coefficient with the alarm reference threshold; a correlation alarm threshold calculator for calculating the alarm threshold based on the amount of acquired data; a decision logic for determining the existence of an alarm condition; a control unit for coordinating the operation of all the units in the system and an operator interface for configuration of the whole system by the operator, determining its operating mode and the display of the alarm conditions.

2. SYSTEM AND METHOD FOR THE SURVEILLANCE OF ILLICIT TRAFFICKING OF SPECIAL NUCLEAR MATERIALS, in agreement to what is claimed in 1, characterized because the pointing of the ensemble radiation detector/telemeter uses automatic pointing mechanisms.

3. SYSTEM AND METHOD FOR THE SURVEILLANCE OF ILLICIT TRAFFICKING OF SPECIAL NUCLEAR MATERIALS, in agreement to what is claimed in 1, characterized because it uses a camera and an image processor running an automatic tracking SW (which allows identifying and following targets) acting synchronously with the radiation detection electronics for the determination of the MO-detector distance (in which case the radiation detector is located within the camera's field of view).

4. SYSTEM AND METHOD FOR THE SURVEILLANCE OF ILLICIT TRAFFICKING OF SPECIAL NUCLEAR MATERIALS, in agreement to what is claimed in 1, characterized because it uses more than one radiation detector.

5. SYSTEM AND METHOD FOR THE SURVEILLANCE OF ILLICIT TRAFFICKING OF SPECIAL NUCLEAR MATERIALS, in agreement to what is claimed in 1, characterized because it uses more than one cameras.

6. SYSTEM AND METHOD FOR THE SURVEILLANCE OF ILLICIT TRAFFICKING OF SPECIAL NUCLEAR MATERIALS, in agreement to what is claimed in 1, characterized because it uses an enhanced processing capability for monitoring more than one MO simultaneously.

7. SYSTEM AND METHOD FOR THE SURVEILLANCE OF ILLICIT TRAFFICKING OF SPECIAL NUCLEAR MATERIALS, in agreement to what is claimed in 1, characterized because it combines a multiplicity of elements to form a network of devices that monitor the same MO along his entire trajectory.

8. SYSTEM AND METHOD FOR THE SURVEILLANCE OF ILLICIT TRAFFICKING OF SPECIAL NUCLEAR MATERIALS, in agreement to what is claimed in 1, characterized because the functions described for this device are implemented, mostly, by a computer program.

9. SYSTEM AND METHOD FOR THE SURVEILLANCE OF ILLICIT TRAFFICKING OF SPECIAL NUCLEAR MATERIALS, in agreement to what is claimed in 1, characterized because the radiation detectors have an intrinsic efficiency dependent of the MO position.

10. SYSTEM AND METHOD FOR THE SURVEILLANCE OF ILLICIT TRAFFICKING OF SPECIAL NUCLEAR MATERIALS, in agreement to what is claimed in 1, characterized because the radiation detectors have poor energy resolution.
